(19) United States
(12) Patent Application Publication
(10) Pub. No.: US 2008/0195829 A1
(43) Pub. Date: Aug. 14, 2008

(54) SELF-PROTECTING MEMORY DEVICE

(75) Inventor: Philip A. Wilsey, Cincinnati, OH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: CLIFTON LABS, INC., Cincinnati, OH (US)

(21) Appl. No.: 12/029,747

(22) Filed: Feb. 12, 2008

Related U.S. Application Data
(60) Provisional application No. 60/889,576, filed on Feb. 13, 2007.
(60) Provisional application No. 60/992,751, filed on Dec. 6, 2007.

(51) Int. Cl. G06F 12/14

(52) U.S. Cl. 711/163; 711/E12.091

(57) ABSTRACT

Described are a self-protecting memory device and a method for protecting information stored in a memory device. The self-protecting memory device includes a storage module, an access control module and a pattern memory module. The access control module communicates with the storage module and is configured to receive memory references from a host system. The pattern memory module communicates with the access control module and stores an expected pattern of memory references. The access control module compares the expected pattern of memory references and memory references received from the host system. Access to the information stored in the storage module is provided or denied by the access control module according to the results of the comparison.

### RELATED APPLICATION

This application claims the benefit of the filing dates of co-pending U.S. Provisional Application Ser. No. 60/889,576, filed Feb. 13, 2007, titled “Self-Protecting Memory Units” and co-pending U.S. Provisional Application Ser. No. 60/992,751, filed Dec. 6, 2007, titled “Self-Protecting Storage,” the entireties of which provisional applications are incorporated by reference herein.

### FIELD OF THE INVENTION

The invention relates generally to self-protecting memory devices. More particularly, the invention relates to a method for monitoring access to a memory device to prevent unauthorized access to information stored on the device. This technique addresses protection of the information from access and also modification by unauthorized users. The method protects information preserving secrets and/or private data as well as preventing unauthorized users from infecting the system with unauthorized data or instructions (e.g., computer viruses). A key feature of this method is that it generally operates in an online fashion, providing continuous authentication checks to insure that only authorized users are allowed to access and modify the stored information.

### BACKGROUND OF THE INVENTION

Protecting sensitive information has become more important as the number of electronic devices such as cell phones, digital camera, personal computers (PCs) continues to increase. Information in the form of data and instructions are stored, for example, in random access memory (RAM) on an electronic device and can include valuable processing techniques or algorithms (e.g., in the form of a software application) which can be used to access or process sensitive data. If the device is obtained by an unauthorized user, reverse engineering procedures can sometimes be used to extract the information and to potentially allow the unauthorized user to access other sensitive data.

Computer viruses are an ongoing threat to most computer systems. Protecting computer systems from viruses is typically based on antivirus software that tries to identify threats based on known virus signatures (e.g., a section of code associated with a known virus). If an infected file is found, the antivirus software quarantines or deletes the file, and in some instances may attempt to repair the file. New viruses can spread rapidly and infect large numbers of computers systems and other types of consumer electronics systems. Consequently, the library of known virus signatures must be frequently updated in an attempt to maintain effective protection. Under many circumstances the above approach is successful; however, as new viruses emerge, including viruses which can “morph” over time, conventional virus scanning may not offer sufficient protection for many computer systems.

What is needed is a method for protecting data and instructions stored in memory devices that overcomes the above described problems.

### SUMMARY OF THE INVENTION

In one aspect, the invention features a self-protecting memory device. The device includes a storage module, an access control module and a pattern memory module. The access control module communicates with the storage module and is configured to receive memory references from a host system. The pattern memory module communicates with the access control module and stores an expected pattern of memory references. The access control module compares the expected pattern of memory references and memory references received from the host system. In some embodiments the access control module compares all of the received memory references with the expected pattern of memory references while in other embodiments only a subset (e.g., only read requests) of the received memory references are used in the comparison. Access to information stored in the storage module is provided by the access control module according to a result of the comparison.

In another aspect, the invention features a self-protecting memory device. The device includes a storage module, an access control module, a pattern memory module and a training module. The access control module communicates with the storage module and is configured to receive memory references from a host system and training memory references. The pattern memory module communicates with the access control module. The training module communicates with the access control module and the pattern memory module. The pattern memory module receives and stores an expected pattern of memory references generated by the training module in response to training memory references when the self-protecting memory module is operated in a training mode. The access control module compares the expected pattern of memory references and memory references received from a host system when the self-protecting memory module is operated in an in use mode. Access to information stored in the storage module is provided by the access control module according to a result of the comparison.

In yet another aspect, the invention features a method for protecting information stored in a memory device. Memory references are received from a host system and are compared to an expected pattern of memory references. Access to the information stored in the memory device is denied according to a result of the comparison of the received memory references and the expected pattern of memory references. In one embodiment the method also includes observing memory references from a host system and generating the expected pattern of memory references based on the observed memory references.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a block diagram of an embodiment of a self-protecting memory device according to the invention.

FIG. 2 is a flowchart representation of an embodiment of a method for training a self-protecting memory device according to the invention.

FIG. 3 is a flowchart representation of an embodiment of a method for using a self-protecting memory device with a host system according to the invention.

### DETAILED DESCRIPTION

In brief overview, the invention relates to a self-protecting memory device and a method for protecting information stored in a memory device from unauthorized access. Information, as used herein, includes software program instructions and other data that can be accessed from memory (e.g., random access memory (RAM)) during program or task execution. The method includes comparing the pattern of memory references from a host system to an expected pattern of memory references. The host system can be any device or system that performs memory references (e.g., memory access operations including read and write operations) to the self-protecting memory device. The expected pattern of memory references is based on one or more memory referencing sequences and is generated in a training session during which the memory references are captured or learned. Alternatively, the expected reference pattern is predefined as a fixed pattern which is stored in the memory device during manufacture or at a later time. Access to the protected information is allowed or denied based upon the results of the comparison. The pattern matching activity in the memory device is continuous and ongoing so that all accesses could be certified as “authorized accesses.” Different embodiments of this invention may check/certify all memory accesses or only a subset of them.

Denial of access to protected information can include one or more of the following actions: destruction of stored information; providing erroneous (or falsified) information to the system attempting to gain access; and operational failure of the memory device. The operational failure mode can be a permanent failure possibly including erasure of stored information, a temporary failure that is re-enabled access after a time delay, a disabling of read requests without affecting write requests, or other forms of disablement. In some embodiments the disablement is enforced only for a portion of the data stored in the memory device.

Memory devices suitable for self-protection according to the invention can be memory components at all levels of memory hierarchy including, by way of example, cache, RAM, and hard drives. Self-protecting memory devices are based on regular patterns of memory access that can be learned, stored and then observed during deployment to enforce protection. Advantageously, self-protecting memory devices are used without any changes or modification to host systems that access the memory devices. Procedurally, it is only necessary to have an initial training period using the memory device as it is normally intended to be used in the field to set the expected reference pattern. Once the self-protecting memory device is trained, a system accessing the self-protecting memory device is used in the same manner as a system using a conventional memory device. The self-protecting memory device protects sensitive information so that if the host system containing the self-protecting memory device is lost, misplaced or stolen, access by others to the protected information stored on the memory device is not easily achieved.

Self-protecting memory devices can be used with a variety of host systems, including consumer devices such as cell phones and digital cameras. Using self-protecting memory devices with these consumer devices provides the device owner an increased level of protection of stored information. Furthermore, because self-protecting memory devices are trained for a specific use, it is possible to use the memory devices for various types of protection enhancement such as monitoring software for viruses and preventing the duplication and reuse of programs or information sold or distributed specifically to an individual user or device. The self-protecting memory devices can be constructed using light-weight pattern matching subsystems so that performance of an associated device or system is not significantly affected.

Self-protecting memory devices can be used in streaming applications by building “fake patterns” of memory references that must be followed to achieve access to stored data. For example, these fake patterns can be constructed using cryptographic functions or other functions with repeatable and observable patterns. The enforcement of such patterns can be variable to allow the construction of self-protecting memory devices with varying levels of strictness. The expected reference patterns that are analyzed and compared can include any type of memory access, including read only access, write only access, relationships between read and write requests, or other relationships of the memory accesses.

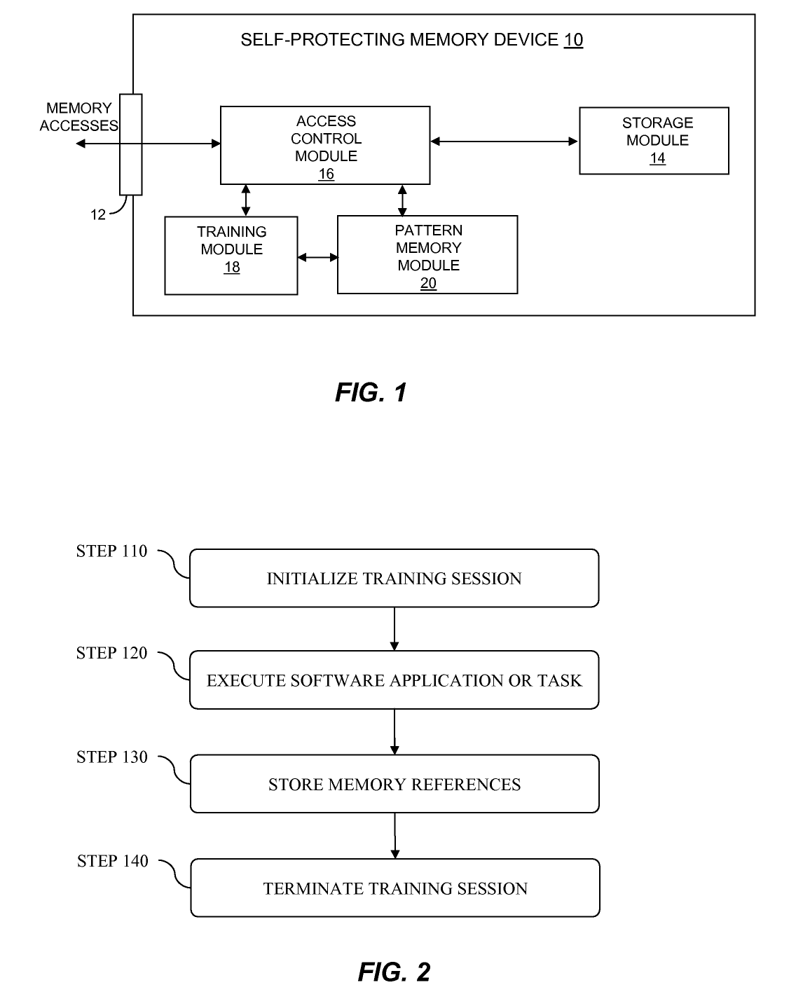

FIG. 1 shows a block diagram of an embodiment of a self-protecting memory device 10 according to the invention. From an external viewpoint, the memory device 10 presents an interface 12 similar to conventional memory devices that includes data lines, address lines, request lines and the like. Internally, the memory device includes a storage module 14 and an access control module 16. The storage module 14 contains the protected information. The access control module 16 “guards” the storage module 14 and provides access to the protected information only when appropriate. The access control module 16 communicates with a training module 18 that captures memory reference patterns and a pattern memory module 20 that stores the captured patterns.

The self-protecting memory device 10 has two main modes of operation, namely, a training mode and an in use mode. In the training mode as shown in the flowchart of FIG. 2, the self-protecting memory device 10 learns or records the expected patterns of memory reference. First, the training mode is initialized (step 110), which includes in some embodiments erasing some or all of the information previously written to and stored in the storage module 14. A software application or task is then executed (step 120) on a host system or training system that accesses the memory device 10. The training module 18 captures the memory references occurring during execution and stores (step 130) these memory references in the pattern memory module 20. The training mode terminates (step 140) at the end of execution of the software application or task.

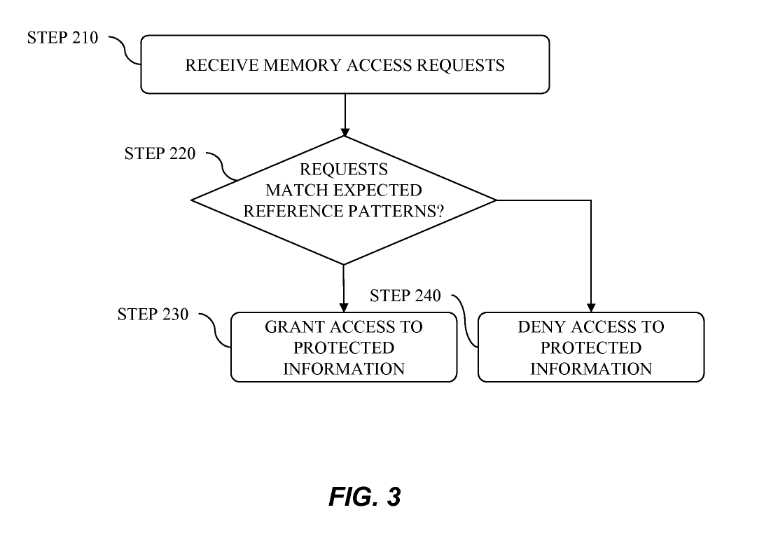

In the in use mode as shown in the flowchart of FIG. 3, the self-protecting memory device 10 receives (step 210) memory references from a host system and compares (step 220) the memory references to one or more expected patterns of memory references. As long as the memory device 10 considers incoming memory reference strings to match an expected pattern, access to protected information (e.g., read and write requests) is allowed (step 230). In contrast, if the memory device 10 receives memory references that fail to match an expected pattern, access is denied (step 240). Access denial can be (i) no response from the memory device, (ii) responding with false or erroneous data, or (iii) some other response/non-response mechanism. In some embodiments, failure to match an expected pattern also results in destruction of at least some of the protected information. Various pattern matching algorithms are used to enforce different levels of strictness of matching as described in more detail below. In addition, the particular operations that are performed upon determination of a failure to match can vary.

Training

Training, as performed in the training mode described above and as used elsewhere herein, means the operation of acquiring the expected patterns of memory references. Training can be implemented statically when the self-protecting memory device 10 is manufactured so that fixed and unchangeable expected reference patterns are stored in the pattern memory module 20. Alternatively, training can be dynamically performed during a training period during which the expected patterns are captured. The training period can be implemented “online,” that is, when the self-protecting memory device 10 is first set up for use with a host system. Conversely, the training period can be implemented “offline” in a special purpose training system that is distinct from the host system with which the self-protecting memory device 10 will later be used. Alternatively, an offline configuration can be used to build the expected reference patterns which are later downloaded to the self-protecting memory device 10. For example, a music vendor can encode a music file (e.g., an MP3 music file) and a pattern key can be sent with the encoded file to the self-protecting memory device 10. Thus the encoded music file can be used only with the self-protecting memory device that has the pattern key. This process ensures that the original music file cannot be retrieved if the encoded music file is copied to a different memory device in another host system.

In one embodiment the self-protecting memory device 10 is trained and re-trained throughout its lifetime. Consequently, a retraining activity by an unauthorized user might be performed in an attempt to retrieve protected information. For improved protection, a retraining activity for the memory device 10 could delete the currently protected information, thereby preventing subsequent access to that information.

Matching

The access control module 16 determines whether access is provided according to a comparison of received memory references with an expected pattern of memory references stored in the pattern memory module 20. In general, access to protected information is granted when the received references match the expected reference patterns as described above for FIG. 3. A match can be an absolute match to a precisely defined pattern of memory references or a probabilistic match that includes an allowable deviation from an absolute match. For probabilistic matching, access is denied if the quality of the match is not accommodated by the allowable deviation. Various artificial intelligence (AI) techniques can be used to support the pattern matching requirements of the access control module 16. Pattern matching can be implemented using neural networks such as those implemented in efficient VLSI circuits that can support operating speeds approximately equivalent to traditional memory devices.

Probabilistic pattern matching enables fabrication of self-protecting memory devices 10 that can be used with software applications having operations and methods of memory referencing that have slight variations. Such variations can be based on inputs, configurations or user directives that introduce variations into the operation of the host system using the self-protecting memory device 10.

Pattern matching is performed against the set of memory references presented to the self-protecting memory device 10 by the associated host system. These memory references are the same memory references that would be issued if the host device were instead using a conventional memory device although in some embodiments memory references may be modified (e.g., encryption of memory addresses) to improve the pattern matching capability. The self-protecting memory device 10 can match all of the memory reference requests or only a subset of them. For example, the expected patterns can be “built” by using one or more of the following: (i) addresses of the memory accesses; (ii) information in the memory read access; (iii) the pattern of addresses and relation of inter-relations of read/write access; and (iv) other subsets of data in the memory accesses.

In the embodiments described above, pattern matching considers the access patterns expected by a “true owner” of a host system using the self-protecting memory device 10; however, in other embodiments access is granted when the received memory references do not match an expected pattern of memory references. In such embodiments, access to protected information is denied or the protected information is deleted when a pattern of memory references matches an expected pattern.

Preventing Access to Protected Information

Several options for responding are possible when the access control module 16 of the self-protecting memory device 10 determines that access should be denied. For example, the memory device 10 can (i) invoke a self-destruct sequence to destroy or delete the protected information; (ii) respond by operating in a rogue manner in which the information read from the memory device 10 is erroneous or falsified; or (iii) fail to respond to the memory access requests. The failure to respond mode can be a permanent failure that includes erasure of the protected information or a temporary failure that permits access attempts after expiration of a predetermined time. Optionally, for self-protecting memory devices 10 having erasure capability, the memory device 10 includes an internal power source to enable complete erasure of protected information in the event that external power is removed during the erasure process.

In one embodiment the failure to respond mode includes disabling the ability to read from the storage module 14 while maintaining an ability to write to the storage module 14. Alternatively, failure to respond can include preventing access attempts until an unlock sequence is received by the self-protecting memory device 10, or until a physical unlocking device (e.g., a key) or a soft key of predefined memory accesses.

Generating Expected Reference Patterns

As described above, the operation of self-protecting memory devices is based in part on the idea that program references are patterned and therefore not easily imitated by rogue agent interrogations; however, in some instances the general access to a memory device is ordered or easily discerned, such as the readout process for downloading information from the memory unit of a digital camera. For these applications the self-protecting memory device can be structured so that the stored information is accessed by synthetic referencing patterns. In one such application, a host system records information to the memory device and a different host system sequentially reads the stored information from the memory device. Normally, the sequential read pattern is easily detected and is therefore able to be reproduced by a rogue agent. According to one embodiment of a method for protecting the information according to the invention, the writing of information to the self-protecting memory device is performed without matching to expected patterns of memory references but the reading of the information requires that a predefined pattern of memory references be followed. The predefined pattern can be generated using, for example, a cryptographic mapping to translate sequential memory addresses to encrypted values that are provided to the self-protecting memory device for decryption and subsequent matching to a pattern of sequential progression.

Examples of Self-Protecting Memory Device Applications

In one example application, an embodiment of the self-protecting memory device according to the invention is adapted for use with a global positioning system (GPS) tracking device. A user wants to ensure that a secret map remains protected from access by others. By generating a software program for the user's GPS tracking device that accesses the self-protecting memory device in a unique way, the user creates a pattern of memory references that is unique to the user's GPS tracking device. After training the self-protecting memory device with the unique pattern, the user is able to limit access to the secret map. Thus the map information is inaccessible to a user of a different GPS tracking device (unless that user also has a software program that accesses its memory device in the same “unique way”).

In another example application, an embodiment of the self-protecting memory device according to the invention is used to limit access to only a subset of the memory requests sent to the self-protecting memory device. This application is useful, for example in the design of a portable covert recording device. The self-protecting memory device may only use read requests from a host device for comparison to the expected pattern of memory references. The device transparently allows all write requests. If the read requests satisfactorily match the expected pattern, the memory device responds by delivering the secure information stored therein. If a match does not occur, the memory device responds by delivering false (benign) information. In this way, self-protecting storage devices can be fabricated for covert digital recordings such as video recordings and audio recordings. The recording of the information can occur using any recording device but the reading of the covertly recorded information is achieved only by providing a correct pattern of memory read requests. Thus the recording device does not need to know or have any information about how to gain read access to the storage device. Furthermore, the self-protecting memory device can store fake (benign) information (such as pictures of famous tourist sites) to be presented upon the occurrence of memory access attempts from unauthorized host devices, thereby disguising the presence of the secure recording. The secured covert information in the memory device is accessed by issuing the correct pattern of memory read requests, presumably at a secure location.

In another example application, an embodiment of the self-protecting memory device according to the invention is used to determine if a computer program is infected by a virus. As described above, computer programs exhibit repeatable patterns of memory references. Such patterns have been exploited by the computer architecture community to build compact memory trace archives that record the memory references of various computer programs. In some instances, researchers have proposed using a Backus-Naur form (BNF) grammar to represent an execution trace of a program. The BNF representation is a compact representation of the possible execution paths of the program that can be captured and used by a self-protecting memory device to verify that the program has not been infected with a computer virus. If infected, the program executes new paths different from the uninfected version. Distributing the expected pattern with a binary image of the program allows the expected pattern to be first loaded into a CPU core where it is used to match the memory referencing trace of that program. (Process IDs are used to separate memory references from distinct tasks in a multi-tasking computer system). As the program memory references occur, a subsystem on the CPU core compares the ongoing memory references for the task to the expected pattern. If the expected pattern matches (either directly or as a “fuzzy match”), continued execution is allowed; however, if there is a failure to match, the program is terminated (and optionally flagged as possibly infected) to protect the computer system.

The above technique for virus detection relies on the memory reference patterns of executions from an uninfected computer program. In contrast, an alternate system can be fabricated based on searching for patterns of memory references identified as being associated with computer viruses. In this example, each computer system maintains a match database of computer viruses that is loaded into the CPU core for matching (as described above); however, a match indicates an infected program. A continuing effort to locate new viruses and to discover and distribute their corresponding patterns enables a rapid response method for computer viruses detection. A key advantage of either of the two above described approaches over conventional virus scanning is that the virus detection method is ongoing and continuously evaluated during the time that the program is executing.

While the invention has been shown and described with reference to specific embodiments, it should be understood by those skilled in the art that various changes in form and detail may be made therein without departing from the spirit and scope of the invention.

What is claimed is:

1. A self-protecting memory device comprising:
a storage module;
an access control module in communication with the storage module and configured to receive memory references from a host system; and
a pattern memory module in communication with the access control module and storing an expected pattern of memory references, the access control module comparing the expected pattern of memory references and memory references received from the host system, the access control module providing access to information stored in the storage module according to a result of the comparison.

2. The self-protecting memory device of claim 1 wherein access is provided to the information when the comparison indicates that the memory references received from the host system match the expected pattern of memory references.

3. The self-protecting memory device of claim 2 wherein the match is a probabilistic match that has an allowable deviation from an absolute match.

4. The self-protecting memory device of claim 1 wherein access is provided to the information when the comparison indicates that the memory references received from the host system do not match the expected pattern of memory references.

5. The self-protecting memory device of claim 1 wherein the storage module comprises a random access memory.

6. The self-protecting memory device of claim 1 wherein the access control module compares the expected pattern of memory references and a subset of the memory references received from the host system.

7. The self-protecting memory device of claim 1 wherein the access control module prevents access to information stored in the storage module and provides false information to the host system.

8. A self-protecting memory device comprising:
a storage module;
an access control module in communication with the storage module and configured to receive memory references from a host system and training memory references;
a pattern memory module in communication with the access control module; and
a training module in communication with the access control module and the pattern memory module, the pattern memory module receiving and storing an expected pattern of memory references generated by the training module in response to training memory references when the self-protecting memory module is operated in a training mode, the access control module comparing the expected pattern of memory references and memory references received from a host system when the self-protecting memory module is operated in an in use mode, the access control module providing access to information stored in the storage module according to a result of the comparison.

9. The self-protecting memory device of claim 8 wherein access is provided to the information when the comparison indicates that the memory references received from the host system match the expected pattern of memory references.

10. The self-protecting memory device of claim 9 wherein the match is a probabilistic match that has an allowable deviation from an absolute match.

11. The self-protecting memory device of claim 8 wherein access is provided to the information when the comparison indicates that the memory references received from the host system do not match the expected pattern of memory references.

12. The self-protecting memory device of claim 8 wherein the access control module compares the expected pattern of memory references and a subset of the memory references received from the host system.

13. The self-protecting memory device of claim 8 wherein the access control module prevents access to information stored in the storage module and provides false information to the host system.

14. A method for protecting information stored in a memory device, the method comprising:
receiving memory references from a host system;
comparing the received memory references and an expected pattern of memory references; and
denying access to the information stored in the memory device according to a result of the comparison of the received memory references and the expected pattern of memory references.

15. The method of claim 14 further comprising:
observing memory references from a host system; and
generating the expected pattern of memory references based on the observed memory references.

16. The method of claim 14 wherein denying access comprises one of a one way permanent disablement of access to the stored information, a disablement of access to a portion of the stored information, a revertible locking disablement and a failure to respond for a predetermined time disablement.

17. The method of claim 14 wherein the received memory references include a memory read operation.

18. The method of claim 14 wherein the received memory references include a memory write operation.

19. The method of claim 14 wherein comparing comprises comparing a subset of the received memory references and an expected pattern of memory references.

20. The method of claim 14 further comprising providing false information to the host system when access is denied to the information stored in the memory device.
